(19) United States
(12) Patent Application Publication
(10) Pub. No.: US 2024/0041679 A1
(43) Pub. Date: Feb. 8, 2024

(54) LIFT ASSIST APPARATUS AND METHODS

(71) Applicants: Benjamin Kenneth Cooksey, Amherst, OH (US); Timothy Andrew Leo, Berea, OH (US)

(72) Inventors: Benjamin Kenneth Cooksey, Amherst, OH (US); Timothy Andrew Leo, Berea, OH (US)

(21) Appl. No.: 17/882,516

(22) Filed: Aug. 5, 2022

(51) Int. Cl. A61G 7/10; A61H 3/04; A61G 5/14

(52) U.S. Cl. CPC A61G 7/1046; A61H 3/04; A61G 5/14; A61H 2201/0192; A61H 2003/043

(57) ABSTRACT

A lift assist device for supporting and lifting the mass (or partial mass) of a human user. In some embodiments, an apparatus is provided which is a fall recovery device to assist in raising human users from an initial position, to a position elevated relative to the initial position. In certain example embodiments, this can include assisting fallen human users to return to a sitting position from a fallen position, or even assisting the user to obtain a standing position. In other embodiments, a hybrid walker and fall recovery device. In alternative embodiments, a hybrid wheeled walker and fall recovery device. In preferred embodiments, a hybrid wheeled walker and fall recovery device which aids a human user to walk while in a standing position and includes a seat which is raisable and lowerable by mechanical means, such as a linear actuator, to assist in returning a fallen human user back to a seated or standing (or other raised) position.

### TECHNICAL FIELD

The various inventions disclosed in this patent application generally relate to lift assist apparatus for supporting and lifting the mass, or partial mass, of a human user. In some embodiments, an apparatus is provided which is a fall recovery device to assist in raising human users from an initial position, to a position elevated relative to the initial position. In certain example embodiments, this can include assisting fallen human users to return to a sitting position from a fallen position, or even assisting the user to obtain a standing position. In other embodiments, a hybrid walker and fall recovery device is provided. In still further alternative embodiments, a hybrid wheeled walker and fall recovery device is disclosed. In preferred (but optional) embodiments, a hybrid wheeled walker and fall recovery device is provided which aids a human user to walk while in a standing position and which includes a seat which is raisable and lowerable by mechanical means, such as a linear actuator, to assist in returning a fallen human user back to a standing position (e.g., if the human user falls).

### BACKGROUND OF THE INVENTIONS

Walking, as the primary mode of adult human locomotion, is an activity assigned high value by most human beings. Unfortunately, however, injuries, disease, aging, or similar mobility inhibiting events can adversely impact the walking ability of humans. Consequently, because walking is assigned such high importance, and because many humans experience mobility-impairing events during their lifetimes, it is unsurprising that past inventors have developed various types of devices to assist walking mobility over literally hundreds, if not thousands, of years. For example, early Egyptian illustrations, believed to be dated between 1580-1350 BC, appear to depict crutches being used by polio virus sufferers.

Crutches, as one of the most well-known walk-assist devices, are still used today and primarily work by letting a user transfer a portion of their weight to an additional point of contact on the ground. A crutch is typically used by placing the upper end of the crutch under at least one arm (e.g., when one crutch is used) with the lower end of the crutch placed on the ground (to be moved as the user walks with crutch-assistance, or otherwise moves around). A cane functions in similar fashion, by providing an additional point of ground contact, and by transmitting bodyweight loads to the ground via an elongated shaft, but without the benefit of removing stress from the user's wrist accomplished by focusing bodyweight loads under the armpit of the crutch user.

Although various cane and crutch variants exist, and even though crutches can be used in pairs or with forearm support for additional stability, innovations in the 20^{th} century provided more effective mobility assistance, such as in the form of walkers or so-called “rollators”. For example, one of the first known “walkers” is described in U.S. Pat. No. 2,656,874, entitled “Walking Aid”, which was filed in 1949 by W. C. Robb. Mr. Robb's walking aid device, as may be seen in the '874 patent, improved on crutches by—among other things—providing additional points of ground contact, which substantially improves a user's standing stability. Additionally, the Robb device provided a frame which rigidly connected the left and right sides of the walker together, eliminating the need for the human user to balance and stabilize two crutch like shafts independently. Consequently, the Robb device is significantly more useful to humans which have greater physical impairments, such as (for example) more severe injury or disease, or more advanced age and muscle and strength loss.

Although walker devices, such as the Robb “walking aid” (and similar walker designs) remain effective and ubiquitous today, further improvements to the art came with the so-called “rollator” type rolling-walkers which are believed to have first come about during or around the year 1978. Because conventional non-wheeled walkers required that a user repeatedly pick up and manually place the walker frame a distance in front of themselves as they progress forward, use of a walker requires threshold levels of endurance and arm strength which aged or injured or ill individuals might not possess. Similarly, mobility distance (or time) can be limited because of early onset exhaustion. Conversely, wheeled-walkers, which typically include wheels mounted at 2 or 4 points of ground contact (e.g., where the four walker legs would normally touch the ground), eliminate the need for a walker to be lifted and manually placed repeatedly as forward steps are taken. Instead, as the wheeled-walker user progresses in a forward direction, the wheeled-walker device can be pushed (instead of lifted), and the wheels allow it to roll forward. This, of course, saves energy of the user and eliminates potential moments of standing instability (when using a walker) during the brief periods when a walker is lifted in the air (and only the user's legs are supporting them).

Human users of walkers or wheeled-walkers are often suffering from leg or back injuries, or they have lost strength or agility or balance during the aging process. Consequently, it is not uncommon for a walker user (regardless of the type) to also have difficulty raising themselves to a seated or standing position (thereby requiring assistance). Or, a walker user may have difficulty lowering themselves to a laying or seated position. Similarly, it is not uncommon for persons with certain medical conditions, or which have aged, to be unable to raise or return themselves to a seated or standing position without assistance after a fall to the ground (e.g., from standing). Despite these difficulties or problems, conventional walkers (or wheeled-walkers) do not solve the problem of adequately assisting human users when raising the user(s) to one or more elevated positions, such as a seated or standing position (or when lowering the user(s) to a seated or laying position). This is surprising, particularly given the importance of human mobility and agility, and the long history of the evolution of mobility assistance devices in the prior art. Indeed, at least one author has commented that despite being the “oldest tool of the orthopaedist”, the“[crutch] is probably also the most neglected [invention] in terms of progress from antiquity until the 20th century.” See International Orthopaedics, 2014 June; 38(6): 1329-1335, author Philippe Hernigou.

In view of these deficiencies in the mobility and/or agility assistance arts, and the long history of invention which did not address or solve them, there is a long felt need for improved or new apparatus or methods which provide lift or raising assistance to human users, or which aid human users in lowering themselves, such as to seated or laying positions. There is also a need for hybrid devices which aid human users with locomotion, while also providing the aforementioned lift/raise and/or lowering assistance.

Referencing the above-described and heretofore unresolved difficulties and problems in the prior art, the applicants for the inventions described herein have addressed, overcome, and/or solved such difficulties and/or problems (in whole or in part) with one or more of the below-described apparatus or methods. It is also a purpose of the herein described apparatus and methods to address other drawbacks and/or other desires for improvements in the art, whether or not currently known, which will become more apparent to the skilled artisan once given the present disclosure.

### SUMMARY OF INVENTION

The inventions described herein, in some embodiments, relate to apparatus (and methods of using such apparatus) which solve or at least ameliorate problems and needs in the art related to humans that require mobility and/or lift (or lowering) assistance. More specifically, in some embodiments, the inventions described herein pertain to apparatus for assisting fallen humans in raising themselves to an elevated position (relative to an initial position), such as (for example) returning to a sitting or standing position and/or pertain to apparatus which can assist humans with compromised strength, agility, or mobility to lower themselves from standing positions to lying or sitting positions (or, as another example, from a sitting position to a lying position). In some embodiments, combination walker and lift assist devices are disclosed for aiding humans with limited or compromised strength, agility, and/or mobility. In other similar embodiments, combination roller-walker and lift assist apparatus are disclosed which aid humans in walking mobility and which also assist the human user, such as if fallen, or if otherwise in need of raising assistance, or when attempting to sit or lie down (e.g., from standing).

In at least one exemplar embodiment, therein is provided a lift assist device for assisting vertical movement of a human comprising: a first handle for gripping by a first human hand; a second handle for gripping by a second human hand; a first leg for contacting a ground surface; a second leg for contacting a ground surface; a frame spanning a vertical distance between the first and the second handles and the first and the second legs, the frame providing structural rigidity to the lift assist device, the structural rigidity being provided to support weight of a human user; a lift member which is raisable in a direction away from the ground and which is lowerable in a direction which is towards the ground, the lift member being structurally configured to raise and lower under mechanical and not human power and provided for assisting vertical movement of a human user away from or towards the ground; wherein the lift member is structurally configured and operable to support a portion of the mass of a human user so that a human user is assisted, when the lift member is operated in a raised direction, in an upwards human movement away from the ground and is also operable to support a portion of the mass of a human user so that a human user is assisted, when the lift member is operated in a lowered direction, in an downwards human movement toward the ground. In preferred embodiment, a mechanical device is operably connected to the lift member for raising and lowering the lift member. In some of these preferred embodiments (but not all of them), the described mechanical device is one or more linear actuators.

Although other structural configurations or mechanical variants are envisioned, in at least one optional embodiment, similar to the above-described embodiments, when a linear actuator is used, a first end of the at least one linear actuator is operably connected to lift assist device frame and a second end of the at least one linear actuator is operably connected to said lift member. In such an example embodiment, when the at least one linear actuator is caused to extend, the lift member is caused to raise away from the ground, and when the at least one linear actuator is caused to retract, the lift member is caused to lower towards the ground. In some embodiments, when a linear actuator is utilized, the at least one linear actuator is a type selected from the group consisting of a hydraulic linear actuator and an electric linear actuator.

For assisting a human user in returning to a sitting or standing (or other raised) position (if fallen), or for assisting a user to a seated or lying (or other lowered) position, various mechanical solutions are envisioned. Although not intended to be specifically limiting to all embodiments, in some embodiments the lift member of the herein described apparatus is a seat platform for a human to sit on (or to grab or hold, if sitting on the seat platform is not possible). In other embodiments, the lift member is a handle surface for a human hand (or hands) to grip. Of course, it is envisioned that some embodiments will include both a seat platform and a handle surface to provide alternative options for a human user. This can be important when a human user falls, for example, because either the seat or the handle surface may be out of reach of the fallen person, particularly if the person has limited strength and/or agility. However, if two options—in different structural positions—are provided, either the handle or seat may be reachable even if the other liftable (or lowerable) surface is not.

In alternative versions of the above-described embodiments, or in different embodiments described herein, an apparatus is provided which includes wheel for aiding mobility of a human user. In such embodiments, the device is configured to by a hybrid device have roller-walker and lift assist functionalities. By roller-walker, it is meant that the device is similar to a conventional walker but with wheels. In preferred embodiments (but not required), at least first and second wheels are provided to be in contact with the ground, with the wheels aiding in locomoting the lift assist device on ground surfaces. Of course, it is envisioned that alternative embodiments may only use one wheel or may use more than two wheels (e.g., 4 or 5, etc.).

In embodiments which utilize wheels, it is contemplated that it will not always be desirable for the wheels to be free-spinning or rotatable, such as when a human user intends to remain stationary (or wishes the lift assist device to remain stationary), such as during use of the lift member after a fall, or when using the lift member to help lower a human user to a sitting or lying (or other lowered) position. In such embodiments, though the feature is optional, one or more brakes are provided which may be engaged to prevent rotation of the first and said second wheels. In some embodiments, the brakes may be activated automatically when a threshold downward force, applied to the lift assist device, is exceeded (such as with a lever and spring assembly). In other embodiments, hydraulic or electrically actuated brakes may be employed. In either event, the embodiments described herein, if they include brakes, are not intended to be limited to a specific type of brake unless otherwise expressly so limited by the claims.

In preferred embodiments of the lift assist devices described herein, a human operable switch is supplied on the apparatus for selectively operating the apparatus, by causing the linear actuator to selectively extend or retract, such that the lift member, alternately, raises or lowers away from or towards a ground surface. Although some embodiments contemplate that the switch will be operated by the human user using the lift assist (and/or mobility) device after a fall (or for assistance in sitting or lying down), in other embodiments a remote switch is installed—or is wirelessly connected (e.g., through wireless communication) or connected by a length of wire—so that a person other than the human user can operate the lift assist device. For example, if a husband is using the lift assist device and requests assistance to be lowered to a seated position, the wife of the husband can be provided with the remote switch, so that she can use the switch to cause the linear actuators to retract to lower the seated member to assist her husband (who may not be sufficiently agile to operate the switch himself).

In certain preferred embodiments, a battery is installed on the lift assist apparatus for supplying power to operate a linear actuator to extend or retract. In these or similar embodiments, the linear actuator is preferably structurally configured such that if battery power supplied to the linear actuator is lost, the linear actuator remains extended to its length as it existed immediately prior to battery power loss. This feature is intended to help prevent fall-type accidents, such as if a human user is seated on the lift platform when the battery dies or the supply of power to the linear actuator (or other mechanical lift device) fails.

In certain embodiments, such as when it is desired to reduce the size or weight of the lift assist apparatus (or reduce linear actuator cost as another example), it may be desirable to include a mechanical device to provide mechanical advantage to any force applied by a linear actuator to raise or lower said lift member. For example, in certain non-limiting embodiments it is desirable to include pivot levers to increase the mechanical lifting ability of an installed linear actuator. An (optional) example of such a pivot lever is a three-sided polygon with one corner pivotally connected to the lift assist apparatus frame, one corner pivotally connected to a linear actuator, and a third corner pivotally connected to the lift member.

In other optional embodiments, it is desirable to use more than one linear actuator. One such example embodiment utilizes at least a second linear actuator operably connected to the frame at a first end and operably connected to the lift member at a second end, with the first linear actuator being located on a first side of the frame and the second linear actuator being located on a second side of the frame opposite the first side. In a more specific example of such an embodiment (using two linear actuators), the actuators are installed in opposite configurations. That is, one actuator will be attached to the frame at a front portion thereof, while being attached to the lift member at a rear portion thereof (with the linear actuator generally being mounted at an angle relative to a vertical axis). In this same embodiment, the second actuator is attached to the frame at a rear portion thereof, while being attached to the lift member at a front portion thereof (with the second linear actuator also being generally mounted at an angle relative to a vertical axis, but in an opposite orientation as compared to the first actuator). Mounted in such reversed orientations with respect to each other, this optional embodiment is more weight balanced and less likely to tip over. In still other embodiments, it may be desired to include additional linear actuators to provide additional stages of lifting or lowering. For example, one linear actuator (or a first linear actuator set) could be used to raise a seat (or handle) from a fully lowered position to seat-type position, and a second linear actuator (or second linear actuator set) could be utilized to further raise the seat (or handle), to assist a user in standing for example. Of course, as an alternative to using two linear actuators (or two linear actuator sets) for lifting in different stages or to different heights, a single linear actuator (or single actuator set) can also be used, so long as the actuator (or actuator set) is suitably sized to extend to the desired lifting height.

Although, as elsewhere disclosed, it is apparent that not all embodiments require wheels, some embodiments contemplated herein are hybridized wheel walker and fall recovery devices. Meaning, the apparatus assists human users in walking activities but can also provide lift (or lowering) assistance when called upon (e.g., such as after a fall). In one such embodiment, there is provided: a hybrid wheeled walker and fall recovery device wherein the lift member comprises a seat surface for a human to sit on and where the device further including at least a first wheel and a second wheel. Also in this (non-limiting) embodiment, each of the first and the second wheels are operably connected to the lift assist device and are located such that the first and the second wheels are in contact with the ground when the lift assist device is located on a ground surface. Moreover, the first and second wheels aid in locomoting the lift assist device on ground surfaces. Of course, in the embodiments which do not utilize wheels, the device may more simply be a hybrid (non-wheeled) walker, combined with fall recovery device functionalities, which is configured to include a structurally vacant standing space for a human user between first and second handles, and wherein the first and the second handles are located at a height such that a human user can utilize the lift assist device as a walk-assist device (in addition to it provide lift and lower assistance with a lift platform or handle as needed).

While repeating that wheels are not required in all embodiments, in the embodiments which utilize wheels, it is contemplated that some iterations thereof will include motors or motorized wheels. More specifically, at least one such wheeled embodiment includes at least one motor to operate the first and the second wheels to drive the lift assist device to a human user located physically distant from the lift assist device. In a similar (but still optional) embodiment, drive-to functionalities are provided. In other words, the lift assist device can drive to a human user, such as if the human user falls and is out of reach of the device. In one of such embodiments, a tracking device for affixing to a human user is included as is a tracking device locator, which is provisioned to locate the tracking device. A control unit is also provided in these (optional) embodiments for controlling a direction of travel of the lift assist device and for directing the lift assist device to drive to a human user located physically distant therefrom. This is accomplished utilizing a location of a human user determined by locating the tracking device with the tracking device locator to determine a target drive location (e.g., when the human user needs mobility assistance or lift assistance). In some (but not all) of these option embodiments, a remote control may also be provided. More specifically, in at least one of these embodiments, a remote control device operable by a human user is included which sends a summoning signal to the control unit of the lift assist device such that the lift assist device is operated by the control unit to drive to the human user.

Certain examples of the invention are now described below, with respect to certain non-limiting embodiments thereof, as illustrated in the following drawings wherein:

### BRIEF DESCRIPTION OF CERTAIN EXAMPLE DRAWINGS

The drawings submitted herewith, which form a part of this patent application, each illustrate an embodiment, or one or more components of an embodiment, of a non-limiting example of applicants' invention. While these drawings depict certain preferred embodiments of applicants' invention, as well as certain particularly desirable features thereof, they are intended to be examples only and should not be construed to limit the scope of applicants' invention.

FIG. 1 illustrates a perspective view of one non-limiting embodiment of a lift assist device according to the subject inventions.

FIG. 2 is a partial perspective view of the embodiment of a lift assist device illustrated in FIG. 1.

FIG. 3 is a two-dimensional, side view of the embodiment of a lift assist device illustrated in FIG. 1, shown being used by a human user, with the lift assist device illustrated in a lowered phase.

FIG. 4 is a two-dimensional, front view of the embodiment of a lift assist device illustrated in FIG. 3.

FIG. 5 is a two-dimensional, side view of the embodiment of a lift assist device illustrated in FIG. 1, shown being used by a human user, with the lift assist device illustrated in a raised phase.

FIG. 6 is a two-dimensional, front view of the embodiment of a lift assist device illustrated in FIG. 5.

FIG. 7 is a two-dimensional, side view of the embodiment of a lift assist device illustrated in FIG. 1, shown being used by a human user as a walking assistant.

### DETAILED DESCRIPTION OF CERTAIN EXAMPLE EMBODIMENTS OF THE INVENTION

For a more complete understanding of the present invention, reference is now made to the following description of various illustrative and non-limiting embodiments thereof, taken in conjunction with the accompanying drawings in which like reference numbers indicate like features. These example embodiments, disclosed and discussed below, will assist in a further understanding of the inventions described and claimed herein, but they are not intended to limit the scope of the invention in any way.

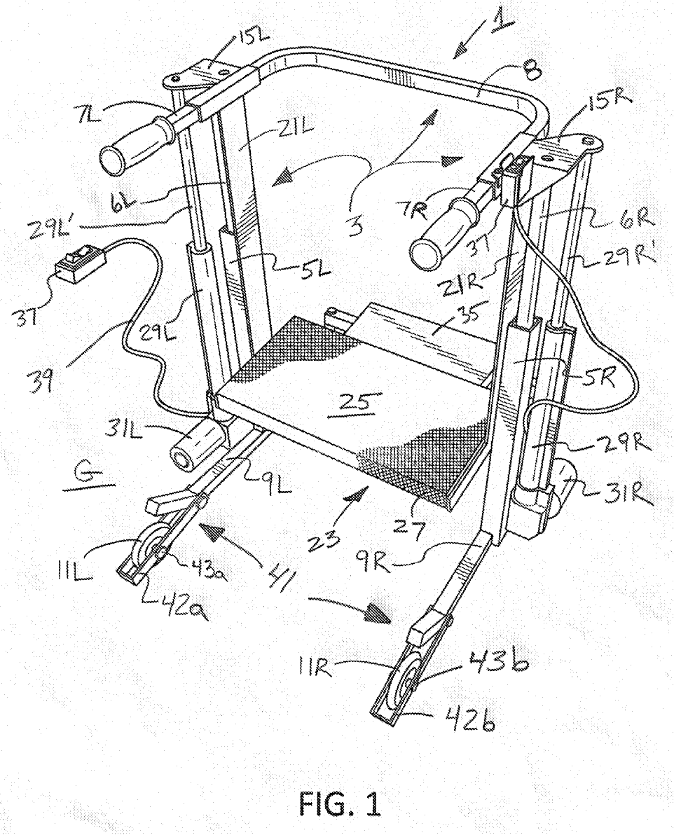

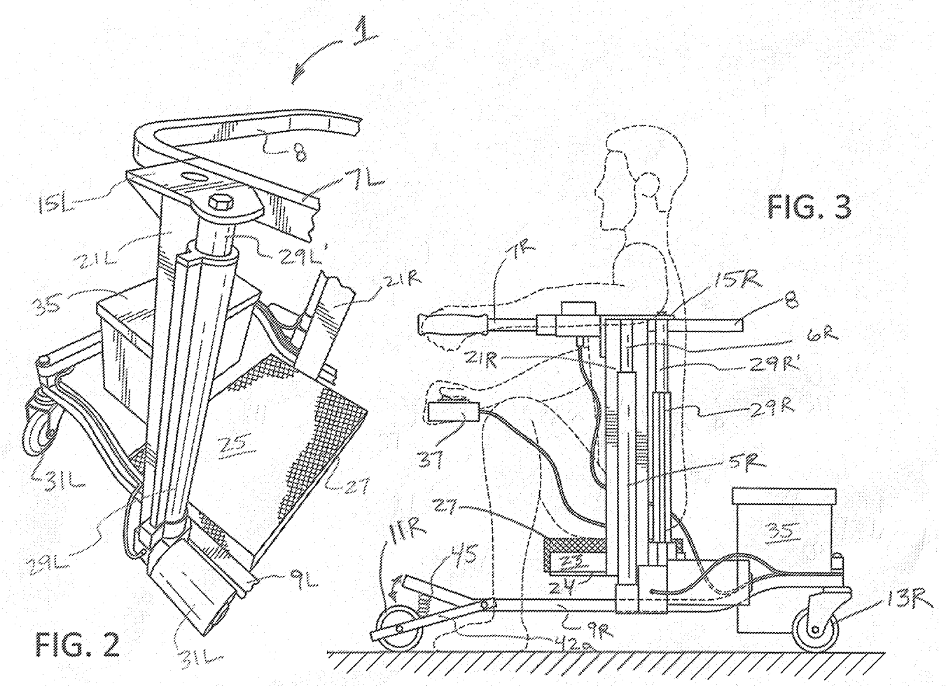

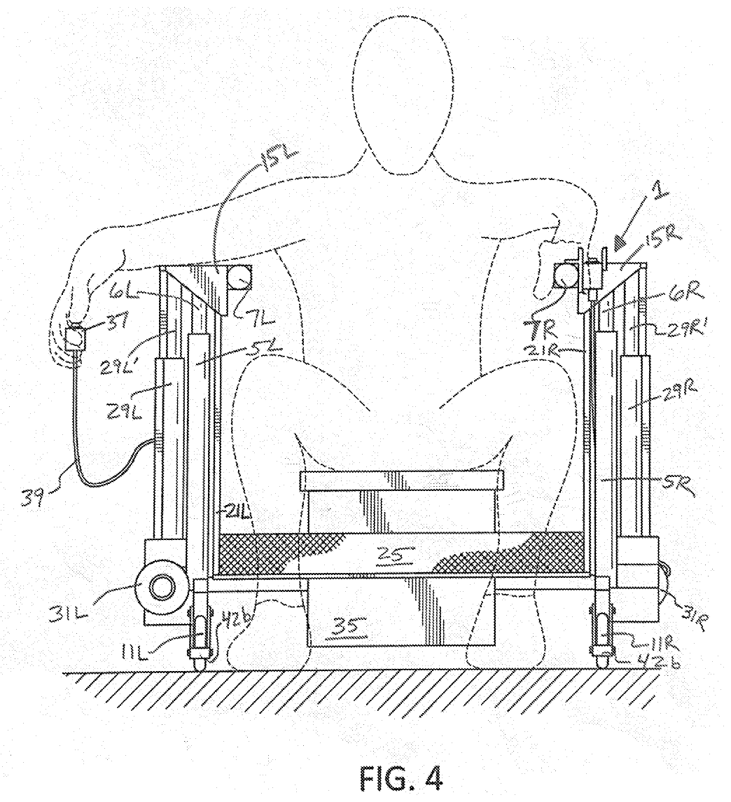

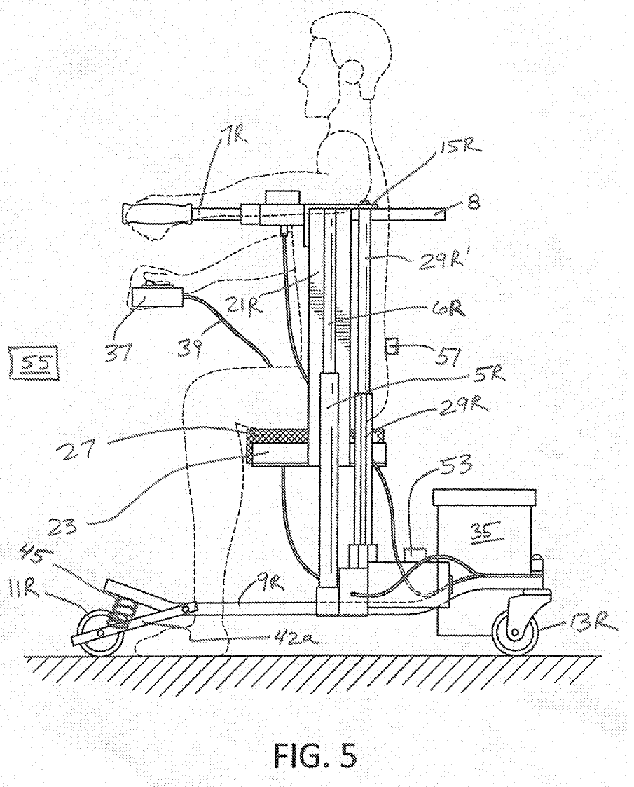

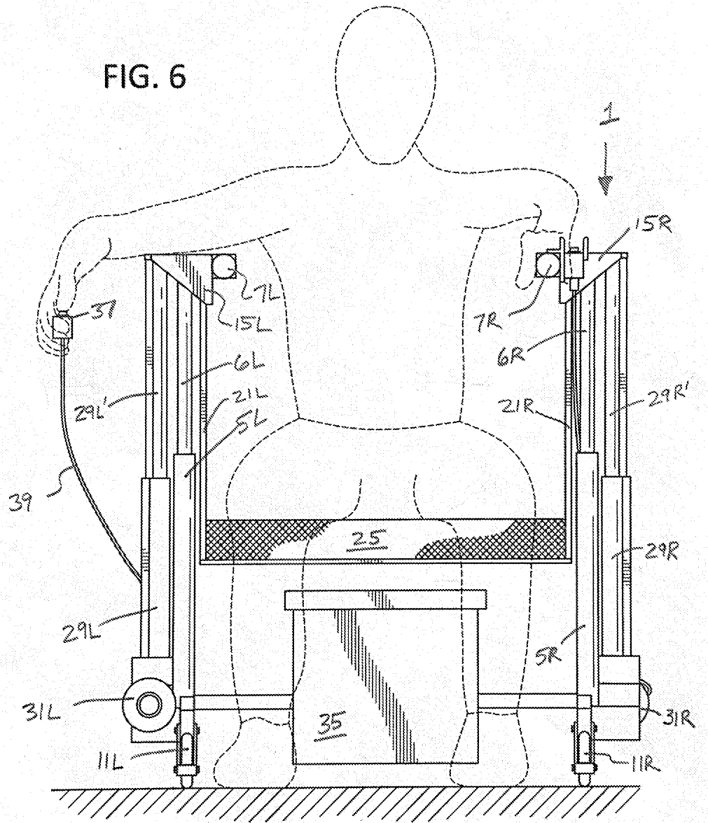

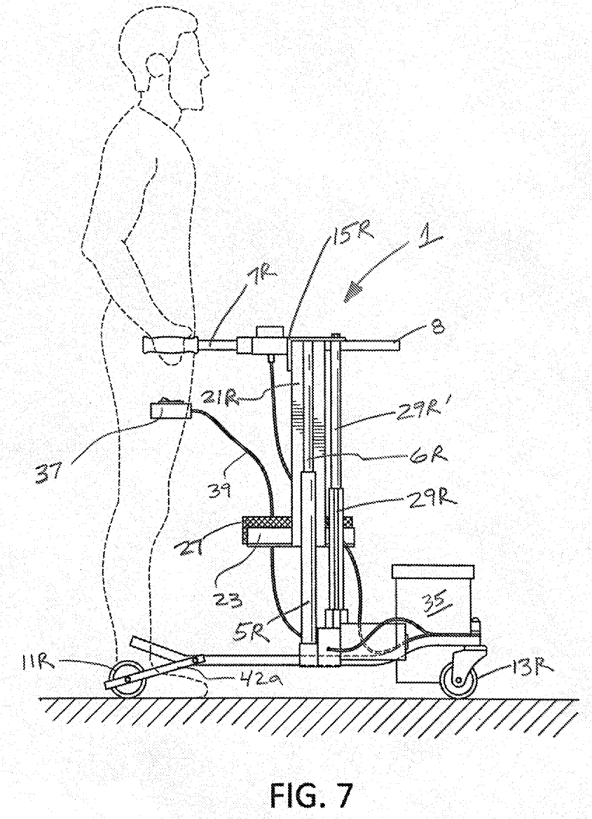

Turning now to FIGS. 1-7, therein is disclosed a lift assist device 1 which addresses and indeed resolves at least some of the long felt needs in the prior art (as discussed in the Background and elsewhere herein). In this specific preferred embodiment which is illustrated, lift assist device 1 generally comprises a walker-type frame, which is configured to surround the front and sides of a human user in use, which also includes (at least) lift assist functionalities to aid human users with strength or agility problems or injuries. More specifically, it is contemplated that a typical user of the herein disclosed device will be a person that both requires walking assistance and which is also at risk of a fall, or which is expected to require (or desire) assistance in raising themselves to an elevated position, such as a sitting position (e.g., from a fall) or standing position (e.g., from sitting or laying). The disclosed embodiment, as an option, also provides lowering assistance if needed. Of course, the embodiment disclosed in FIG. 1 is an example embodiment only, and other embodiments which only provide lift assistance, without providing walking assistance, and also without providing lowering assistance, are also contemplated as within the scope of the herein disclosed inventions.

Referring again to the figures, the frame 3 of lift assist device 1 generally includes left and right vertical frame members 5L and 5R which are joined at their upper ends at least by a crossbar 8 from which left and right handles 7L and 7R extend backwards (in a direction in reverse of the expected direction of walking by the user). Handles 7L and 7R are intended to be gripped by human hands and therefore optionally include padding or grips, for comfort and/or for preventing grip-slippage. Moreover, the handles are preferably located at a height so when they are gripped by a user, the user's elbows are slightly bent to reduce strain and/or optimize blood flow of the user. Of course, other grip heights may be utilized such as recommended by a doctor or simply for comfort. Still further, it is contemplated that some embodiments will be designed to allow the handle height to be raised or lowered—in other words customized—depending on the height, stature, preferences, and/or ergonomic and/or medical needs of the intended human user. For sake of clarity, the terms “left” and “right” are used herein for describing the invention only (and are not otherwise intended to be limiting) and have meanings which are contextual, being relative to the forward-facing direction of the device 1.

At the lower ends of frame 3, left and right frame legs 9L and 9R are mechanically connected to the to left and right vertical frame members 5L and 5R respectively. The mechanical connection in the disclosed embodiment is fixed in nature (e.g., achieved by welds or fasteners or similar mechanical connection) but flexible or partially-rotatable pivot type connections are also envisioned, such as for ergonomics during walking (or for other reasons). Each leg 9L and 9R, as illustrated, is elongated to extend both forward and rearward of the base of each vertical frame member 5L and 5R respectively (for apparatus stability). Moreover, in the illustrated embodiment, a wheel is rotatably attached at each end of the legs of the lift assist device, as wheels 11L, 11R, 13L, and 13R, effectively making this a wheeled-walker type embodiment (as opposed to a non-wheeled walker-type). As disclosed elsewhere herein, however, not all embodiments envisioned by the inventor will include wheels, or they may include less wheels—such as two wheels mounted at the front of the device (similar to wheels 13L and 13R (other wheels being omitted)), or such as two wheels mounted at the rear (similar to wheels 11L and 11R (other wheels being omitted)).

In the depicted embodiment shown in FIG. 1, the frame members are disclosed as comprising square metal tubing. Of course, other materials or configurations may be used to accomplish different objectives, such as to tailor the weight or strength of the lift assist device 1. For example, solid shafts could be employed (e.g., made of metal or wood or plastic), or different configurations of hollow tubing can be employed, such as round or rectangular tubes.

Located preferably generally between the vertical frame members is a cradle comprised of left and right cradle arms 21L and 21R which are slidably engaged to frame members 5L and 5R respectively. Extending between cradle arms 21L, 21R is a lift member 23 which includes a seat surface 25 configured for a human user to sit on or to grab with their hands if sitting is not possible (or preferred for a given use). Seat surface 25 may be padded of course (with pad 27) or otherwise be designed to include ergonomic features to improve functionality or comfort. Further, the seat may include a handle surface for grasping by a human hand (or hands) such as if lift assistance is desired without requiring a human user to sit in the seat surface 25 (e.g., such as if a fallen user cannot reach a seated position but can reach the seat, or a provided seat handle (optional), with his/her hand(s)). Lift member preferably includes a structural support member 24 extending between and connected to the cradle arms 21L, 21R, which is suitably constructed to safely support the weight of a wide range of human beings. In more preferred embodiments, the support member, along with cradle arms 21L, 21R are each over-engineered such as to support 2-4 times the weight of an average human (e.g., for safety to ensure that the structure does not break during use).

Cradle arms 21L and 21R are (in this non-limiting preferred embodiment) slidably engaged to vertical frame members 5L, 5R so that the cradle—including its lift member 23—can travel upwards and downwards relative to the ground, by sliding up and down along the length of the vertical frame members (or in other words travel up and down generally orthogonally relative to the ground surface). Of course, it is not required that the cradle raise and lower in a precise vertical orientation, and variants of raising and lowering angles can be employed when desired (e.g., such as by angling the vertical frame members relative to orthogonal).

In order to facilitate the raising or lowering of the cradle in this preferred embodiment, left and right lift brackets assemblies 15L and 15R are provided which bridge-connect handles 7L and 7R (or the arms or other structural member affiliated with such handles) to the upper ends of cradle arms 21L, 21R, as well as to other operational parts of the lift assist device. More specifically, in this embodiment, vertical frame members 5L, 5R each include a cylindrical shaft 6L and 6R which nests within the interior of the hollow metal tubing comprising each of the frame members, with the upper most end of each of the cylindrical shafts connected to the respective left and right lift bracket assemblies 15L and 15R. Additionally, so that the cradle (and therefore lift member 23) can be lifted (or lowered) with mechanical assistance (as opposed to being human powered), lift assist device 1 also includes left and right linear actuators 29L and 29R with the extensible portion of the actuators 29L′ and 29R′ preferably also connected to a plate portion of each of lifting brackets assemblies 15L and 15R. In other words, and in sum, lift bracket assemblies 15L and 15R each interconnect the handles, cradle arms, cylindrical column ends, and linear actuator extensible ends of the device so that when linear actuators 29L and 29R are operated (i.e., caused to extend) handles 7L, 7R lift upwards vertically as lift member 23 is also lifted (via lifting of cradle arms 21L, 21R). This is, of course, because the lower ends of linear actuators 29L, 29R are each (preferably) fixedly attached at or near a bottom (or ground-proximal) region G of the lift assist device. Thus, when the linear actuators are actuated, because the lower ends are attached in fixed locations, the extensible ends lift upwards, while the cylinder ends remain in place. Although the term “fixed” (or variants thereof) is used to describe the connection of the lower cylinder ends of the linear actuators, the connection may be a pivot connection type which may in fact facilitate better functionality, including if a lever is used (between the linear actuator and one or more frame members) to provide or increase mechanical advantage (i.e., by amplifying applied forces). Of course, it is possible and indeed envisioned to invert the linear actuators in alternative embodiments or to manufacture embodiments where the lower linear actuator connection also travels (such as when utilizing intermediary levers). Moreover, even though screw type linear actuators are disclosed in FIG. 1, other linear actuator types may be used, such as hydraulic types. Still further, other lift mechanisms entirely may be utilized such as lifting columns.

In order to provide power to linear actuators 29L, 29R (so that they can extend and retract to lift and lower lift member 23), a battery 35 is provided in the disclosed embodiment which is sized to be able to provide sufficient power to operate actuator motors 31L, 31R. Battery 35 can be of any type (lithium, lead acid, etc.), but in the most preferred embodiments is easily rechargeable such that a user with limited physical agility and/or mobility may readily re-charge the battery without additional human assistance. For this reason, a battery which can be plugged into a conventional wall outlet (e.g., with a supplied cord) is preferred.

In versions of the lift apparatus which include wheels, it is understood that it will sometimes (but not always) be desired to include brakes for the wheels so that the brakes can be employed, so that the lift apparatus remains stationary—despite applied directional forces, or despite being on an unlevel ground surface—when desired. For example, if a user of the apparatus is particularly unstable when standing (e.g., due to injury, disease, or age), brakes for the wheels may be recommended because the user is unable to stabilize the apparatus without the brakes. Accordingly, in the preferred embodiment illustrated in FIG. 1, legs 9L and 9R include brakes 41 comprising angled tubing extensions, with wheel mount brackets 42a, 42 b for carrying wheels 11L, 11R, the brackets being pivotally connected at pivots 43a, 43b, at the junction of the angled tubing extension and main leg portions. Springs 45 (preferably duplicated on each side, but of any suitable variety) (see FIG. 3) are disposed between the angled tubing extensions and wheel mount brackets, and have sufficient spring constants such that the angled tubing extensions are biased away from the wheels—so that wheels 11L, 11R can spin freely—when bearing only the weight of the lift assist apparatus 1. However, when weight is applied which exceeds the force of the spring constants—such as when a human user applies force to handles 7L, 7R—the angled tubing extensions bias against the wheels causing them to “brake” (i.e., no longer spin freely). Of course, brake pad type (or other suitable friction inducing) materials may also be utilized to increase the stopping force of the provided brakes.

In order to operate the linear actuators, and therefore to cause the lift member to raise or lower, a switch 37 is provided which, in this embodiment, is a corded switch which includes a length of cord (or cable) 39 sufficient to allow the switch to be passed to a third party non-user of the device, so that the third party can operate the lift assist device, if the user of the device needs assistance. Alternatively, the switch can be operated by the device user. In some preferred embodiments, two switches are provided—one fixedly mounted on the apparatus and another which can be operated remotely (because it is either attached via a length of cable or because it is operable wirelessly). Of course, in some embodiments only a single switch is used which is mounted on the device with no remote-operation capabilities. In preferred embodiments, switch 37 includes at least three positions or at least three modes, including 1) a “raise” mode (or position)—which raises the lift member; 2) a “lower” mode (or position)—which lowers the lift member; and 3) a neutral mode (or position) in which the lift member remains at a stationary height. Regardless of the type of switch used, it is preferred that the selected linear actuators be designed so that if power is lost to the apparatus (e.g., because of a dead battery), the actuators will remain at their current extended length (and not collapse to endanger the user).

When the embodiment of lift assist apparatus 1 depicted in FIG. 1 is used as a wheeled walker-type device, the man or woman stands between the frame members placing his/her hands on handles 7L, 7R for support while in a standing position. The user can then walk by pushing apparatus 1 forward so that it rolls on wheels 11L, 11R, 13L, 13R, take a step towards the already forward-advanced apparatus (back into a position between its frame members), and then repeat the procedure so that the user is provided with mobility assistance when walking. If braking is needed, force can simply be applied to the apparatus handles in a direction towards the ground.

When a user wishes to use lift assist apparatus 1 as a “lift” device, such as if the user has fallen to the ground, the device user preferably raises his/herself to a seated position on seat surface 25 (covered by seat pad 27) which, in this embodiment, orients the user so that they are facing in a rearward direction (opposite the walking direction of the device). Once seated as such, switch 37 can be operated to a “lift” or “raise” position so that linear actuators 29L, 29R begin extending, raising both lift member 23 and handles 7L, 7R simultaneously (because of their similar connections to lift brackets assemblies 15L and 15R). Maintaining the relative distance between the lift member and handles is helpful to a user, because the raising of the seat (and thus the user seated on the seat) does not place the user in an awkward position relative to the apparatus handles. In other words, the handles remain well-positioned to continue to provide stability-assistance to the user (even when lifting, when the user is in a seated position). In an alternative scenario where the apparatus user is unable to raise his/herself to a seated position (from a fallen position), the lift apparatus can nevertheless be used for lift assistance by gripping lift member 23 with the user's hand (or hands) (either directly or utilizing a supplied handle connected to lift member 23 or seat 25). After a suitable grip is obtained, the lift member can be lifted—just as in the seated mode—by operating switch 37 so that it is in a lift or raise position (or a nearby non-user can operate switch 37 for the user).

When using lift assist apparatus for a lowering operation, such as to assist a person in lowering themselves from a seated or standing position to a chair or a bed, the reverse operation (as compared to the immediately preceding paragraph) is performed. For example, if a user is using the device as a wheeled-walker and the user wishes to lower themselves to a bed (or simply desires assistance reaching a low shelf or cabinet or object on the floor), lift member 23 can be positioned (e.g., possibly raised) so that it is at the relative height of the user's gluteal muscles. Once in position as such, the user can turn around to face the rearward direction, lean themselves or seat themselves on seat surface 25 and then operate switch 37 to the “lower” mode so that linear actuators 29L, 29R retract, lowering lift member 23 and therefore the human user of the device, but while also providing physical support to the user so that they do not fall. If the apparatus is being used to transition to a laying position, the user can first walk the device to a bedside and then—using the handles of the device for support—transfer themselves from seat 25 to a bed surface. Alternatively, if the user is using the apparatus to reach a low object, after the object is recovered, switch 37 can be operated to its raise (or lift) position, returning the user to a seated or standing position so that they may continue walking locomotion.

Although not included in many embodiments, some optional embodiments (such as described in the Summary of Invention section) include self-driving capabilities as well as tracking and locating functions. For example, in some of these embodiments, a tracking device 51 may optionally be worn by an apparatus user with the apparatus itself (optionally) including a tracking device locator 53. In these embodiments, a wireless remote control is also preferably supplied such that if or when a user experiences a fall which is not near the lift assist apparatus, the wireless remote control can be used to activate a “find” function whereby the apparatus—using the tracking device locator—locates the human user and then optionally drives the lift assist apparatus to the user to assist them in returning to a standing position. In similar but different embodiments, of course, the tracking functions can be omitted but a wireless remote can be supplied (with typical forward, reverse, and left and right controls) to manually drive the apparatus to the fallen device user.

Once given the above disclosure, many other features, modifications, and improvements will become apparent to the skilled artisan. Such features, modifications, and improvements are therefore considered to be part of this invention, without limitation imposed by the example embodiments described herein. Moreover, any word, term, phrase, feature, example, embodiment, or part or combination thereof, as used to describe or exemplify embodiments herein, unless unequivocally set forth as expressly uniquely defined or otherwise unequivocally set forth as limiting, is not intended to impart a narrowing scope to the invention in contravention of the ordinary meaning of the claim terms by which the scope of the patent property rights shall otherwise be determined:

We claim:

1. A lift assist device for assisting vertical movement of a human comprising:
a first handle for gripping by a first human hand;
a second handle for gripping by a second human hand;
a first leg for contacting a ground surface;
a second leg for contacting a ground surface;
a frame spanning a vertical distance between said first and said second handles and said first and said second legs, said frame providing structural rigidity to said lift assist device, said structural rigidity being provided to support weight of a human user;
a lift member which is raisable in a direction away from the ground and which is lowerable in a direction which is towards the ground, said lift member being structurally configured to raise and lower under mechanical and not human power and provided for assisting vertical movement of a human user away from or towards the ground;
wherein said lift member is structurally configured and operable to support a portion of the mass of a human user so that a human user is assisted, when said lift member is operated in a raised direction, in an upwards human movement away from the ground and is also operable to support a portion of the mass of a human user so that a human user is assisted, when said lift member is operated in a lowered direction, in an downwards human movement toward the ground.

2. The lift assist device according to claim 1 further including a mechanical device operably connected to said lift member for raising and lowering said lift member.

3. The lift assist device according to claim 1 further including a mechanical device operably connected to said lift member for raising and lowering said lift member, said mechanical device being structurally configured to provide mechanical advantage to any force applied to raise or lower said lift member.

4. The lift assist device according to claim 2 wherein said mechanical device comprises at least one linear actuator.

5. The lift assist device according to claim 4 wherein a first end of said at least one linear actuator is operably connected to said frame and a second end of said at least one linear actuator is operably connected to said lift member; and
wherein when said at least one linear actuator is caused to extend, said lift member is caused to raise away from the ground, and when said at least one linear actuator is caused to retract, said lift member is caused to lower towards the ground.

6. The lift assist device according to claim 5 wherein said at least one linear actuator is a type selected from the group consisting of a hydraulic linear actuator and an electric linear actuator.

7. The lift assist device according to claim 1 further including a linear actuator for raising and lowering said lift member and wherein said lift member comprises a seat surface for a human to sit on.

8. The lift assist device according to claim 1 further including a linear actuator for raising and lowering said lift member and wherein said lift member comprises a handle surface for a human to grip.

9. The lift assist device according to claim 5 wherein said lift member comprises a seat surface for a human to sit on and further including at least a first wheel and a second wheel, each of said first and said second wheels operably connected to said lift assist device and located such that said first and said second wheels are in contact with the ground when said lift assist device is located on a ground surface; and
wherein said first and said second wheels aid in locomoting said lift assist device on ground surfaces.

10. The lift assist device according to claim 9 further including a human operable switch for selectively operating said lift assist device, by causing said linear actuator to selectively extend or retract, such that said lift member, alternately, raises or lowers away from or towards a ground surface.

11. The lift assist device according to claim 10 further including one or more brake mechanisms which engage to prevent rotation of said first and said second wheels when a threshold downward force, applied to said lift assist device, is exceeded.

12. The lift assist device according to claim 11 further including a battery for supplying power to operate said linear actuator to extend or retract, and wherein said linear actuator is structurally configured such that if battery power supplied to said linear actuator is lost, said linear actuator remains extended to its length as it existed immediately prior to battery power loss.

13. The lift assist device according to claim 12 further including a remote switch for selectively operating said lift assist device from a location distanced from said lift assist device, by causing said linear actuator to selectively extend or retract, such that said lift member, alternately, raises or lowers away from or towards a ground surface, said remote switch communicating with said lift assist device utilizing a mechanism selected from the group consisting of a wired connection and a wireless connection.

14. The lift assist device according to claim 1 further including at least a first wheel and a second wheel, each of said first and said second wheels operably connected to said lift assist device and located such that said first and said second wheels are in contact with the ground when said lift assist device is located on a ground surface;
said first and said second wheels being configured to aid in locomoting said lift assist device on ground surfaces; and
further including at least one motor to operate said first and said second wheels to drive said lift assist device to a human user located physically distant from said lift assist device.

15. The lift assist device according to claim 14 further including a tracking device for affixing to a human user;
said lift assist device further including a tracking device locator, said tracking device locator being provisioned to locate said tracking device; and
a control unit for controlling a direction of travel of said lift assist device and for controlling said lift assist device to drive to a human user located physically distant therefrom, utilizing a location of a human user determined by locating said tracking device with said tracking device locator to determine a target drive location, when the human user needs mobility assistance or lift assistance.

16. The lift assist device according to claim 15 further including a remote control device operable by a human user to send a summoning signal to said control unit of said lift assist device such that lift assist device is operated by said control unit to drive to said human user.

17. The lift assist device according to claim 5 further including a lever connected between said at least one linear actuator and one of said frame or said lift member to provide mechanical advantage to the lifting force of said linear actuator.

18. The lift assist device according to claim 5 further including at least a second linear actuator operably connected to said frame at a first end and operably connected to said lift member at a second end; and
wherein said first linear actuator is located on a first side of said frame and said second linear actuator is located on a second side of said frame opposite said first side.

19. The lift assist device according to claim 18 wherein said lift assist device is a hybrid walker and fall recovery device which is configured to include a structurally vacant standing space for a human user between said first and said second handles, and wherein said first and said second handles are located at a height such that a human user can utilize said lift assist device as a walk-assist device.

20. The lift assist device according to claim 19 wherein said lift assist device is a hybrid wheeled walker and fall recovery device wherein said lift member comprises a seat surface for a human to sit on and further including at least a first wheel and a second wheel, each of said first and said second wheels operably connected to said lift assist device and located such that said first and said second wheels are in contact with the ground when said lift assist device is located on a ground surface; and
wherein said first and said second wheels aid in locomoting said lift assist device on ground surfaces.
